(19) United States
(12) Patent Application Publication
(10) Pub. No.: US 2014/0132884 A1
(43) Pub. Date: May 15, 2014

(54) POSITIONING DEVICE, BACKLIGHT MODULE, AND LIQUID CRYSTAL DISPLAY

(71) Applicant: Shenzhen China Star Optoelectronics Technology Co., Shenzhen, Guangdong (CN)

(72) Inventor: Yajun Yu, Shenzhen (CN)

(21) Appl. No.: 13/702,624

(22) PCT Filed: Nov. 17, 2012
(86) PCT No.: PCT/CN2012/084786

§ 371 Date: Dec. 7, 2012

(30) Foreign Application Priority Data
Nov. 12, 2012 (CN) 201210448291.1

(51) Int. Cl. F21V 8/00; G02F 1/1335

(52) U.S. Cl. CPC G02B 6/0035; G02F 1/133524
USPC 349/62; 362/623

(57) ABSTRACT

A positioning device of a backlight module is disclosed. The positioning device is for positioning a reflective sheet and a light guiding plate. The reflective sheet and the light guiding plate are respectively fixed on the positioning device such that the reflective sheet moves together with the light guiding plate. The backlight module and a liquid crystal display are also disclosed. By adopting the positioning device, the reflective sheet moves together with the light guiding plate such that the location of the reflective sheet is not affected in the assembly process of the light guiding plate. As the reflective sheet is precisely positioned and there is also a buffer for engaging the inflation of the reflective sheet, the optical uniformity is enhanced.

### BACKGROUND OF THE INVENTION

This application claims priority to China Patent Application No. 201210448291.1 filed on Nov. 12, 2012 entitled, POSITIONING DEVICE, BACKLIGHT MODULE, AND LIQUID CRYSTAL DISPLAY, all of the disclosures of which are incorporated herein by reference in their entirety.

1. Field of the Invention

Embodiments of the present disclosure relate to liquid crystal display technology, and more particularly to a positioning device, a backlight module, and a liquid crystal display.

2. Discussion of the Related Art

In an assembly process of a backlight module, positioning devices arranged at four edge corners are adopted for respectively fixing a reflective sheet and a light guiding plate. However, the typical positioning devices have several problems. First, as the reflective sheet may inflate due to high temperature, a buffer is needed for engaging the inflation. With such configuration, the distances between the reflective sheet and the two positioning devices may not be the same, and the optical performance of the backlight module is seriously affected. Second, the location of the reflective sheet may change due to the movement of the light guiding plate. Thus, the distances between the reflective sheet and two sides of the backplane are different.

### SUMMARY

The object of the claimed invention is to provide a positioning device, a backlight module, and a liquid crystal display. The reflective sheet is precisely positioned in the assembly process.

In one aspect, a positioning device of a backlight module is for positioning a reflective sheet and a light guiding plate on a backplane, wherein the positioning device is for fixing the reflective sheet and the light guiding plate such that the reflective sheet moves together with the light guiding plate.

Wherein each of the positioning devices includes: a base; a limit member and a protrusion arranged on a top surface of the base, the protrusion is arranged on an edge of the top surface, wherein: internal sidewalls of the limit member and the protrusion surround the top surface so as to form a limit slot; and a gap is formed between the limit member and the protrusion to receive flanges of the reflective sheet such that a movement of the reflective sheet is limited.

Wherein the light guiding plate is fixed in the limit slot.

In another aspect, a backlight module includes: a backplane, a reflective sheet, a light guiding plate and at least one set of positioning device, the backplane includes horizontal plates and vertical plates vertical to the horizontal plates, the at least one set of positioning device is arranged in two corners between the vertical plates and the horizontal plate, wherein the reflective sheet and the light guiding plate are respectively fixed by the at least one positioning set such that the reflective sheet moves together with the light guiding plate.

The positioning device includes: a base; a limit member and a protrusion arranged on a top surface of the base, the protrusion is arranged on an edge of the top surface, wherein: internal sidewalls of the limit member and the protrusion surround the top surface so as to form a limit slot, and a gap is formed between the limit member and the protrusion; and the reflective sheet is received in the limit slot, two flanges of at least one edge of the reflective sheet are respectively arranged in two gaps of the set of positioning device, and the two flanges are limited in the two protrusions of the set of positioning device.

Wherein the light guiding plate is fixed in the limit slot.

Wherein a width of the gap is larger than that of the flange so that a buffer is provided for engaging a horizontal inflation of the reflective sheet.

Wherein two opposite edges of the two flanges abut against two edges of the protrusions facing away from each other.

Wherein a distance between the two opposite edges of the two flanges is equal to a distance between the two edges of the protrusions facing away from each other.

Wherein the light guiding plate is fixed in the limit slot.

Wherein a width of the gap is larger than that of the flange so that a buffer is provided for engaging a horizontal inflation of the reflective sheet.

In another aspect, a liquid crystal display includes: a backlight module includes a backplane, a reflective sheet, a light guiding plate and at least one set of positioning device, the backplane includes horizontal plates and vertical plates vertical to the horizontal plates, the at least one set of positioning device is arranged in two corners between the vertical plates and the horizontal plate, wherein the reflective sheet and the light guiding plate are respectively fixed by the at least one positioning set such that the reflective sheet moves together with the light guiding plate.

Wherein the positioning devices includes: a base; a limit member and a protrusion arranged on a top surface of the base, the protrusion is arranged on an edge of the top surface, wherein: internal sidewalls of the limit member and the protrusion surround the top surface so as to form a limit slot, and a gap is formed between the limit member and the protrusion; and the reflective sheet is received in the limit slot, two flanges of at least one edge of the reflective sheet are respectively arranged in two gaps of the set of positioning device, and the two flanges are limited in the two protrusions of the set of positioning device.

Wherein the light guiding plate is fixed in the limit slot.

Wherein a width of the gap is larger than that of the flange so that a buffer is provided for engaging a horizontal inflation of the reflective sheet.

Wherein two opposite edges of the two flanges abut against two edges of the protrusions facing away from each other.

Wherein a distance between the two opposite edges of the two flanges is equal to a distance between the two edges of the protrusions facing away from each other.

Wherein the light guiding plate is fixed in the limit slot.

Wherein a width of the gap is larger than that of the flange so that a buffer is provided for engaging a horizontal inflation of the reflective sheet.

By adopting the positioning device, the reflective sheet moves together with the light guiding plate. As the reflective sheet is precisely positioned and there is also a buffer for engaging the inflation of the reflective sheet, the optical uniformity is enhanced.

### BRIEF DESCRIPTION OF THE DRAWINGS

FIG. 1 is a schematic view of the backlight module assembled with the reflective sheet in accordance with one embodiment.

FIG. 2 is a schematic view of the backlight module assembled with the light guiding plate in accordance with one embodiment.

FIG. 3 is a schematic view of the positioning device of the backlight module in accordance with one embodiment.

FIG. 4 is an enlarged view of portion A of FIG. 1.

FIG. 5 is an enlarged view of portion B of FIG. 1.

### DETAILED DESCRIPTION OF THE EMBODIMENTS

Embodiments of the invention will now be described more fully hereinafter with reference to the accompanying drawings, in which embodiments of the invention are shown.

In one embodiment, a backlight module includes a backplane 1, a reflective sheet 2, a light guiding plate 5, and at least one set of positioning device 3. The reflective sheet 2 and the light guiding plate 5 are respectively fixed on the positioning device 3 so that the light guiding plate 5 and reflective sheet 2 move together with each other. As such, the location of the reflective sheet 2 is not affected in the assembly process of the light guiding plate 5.

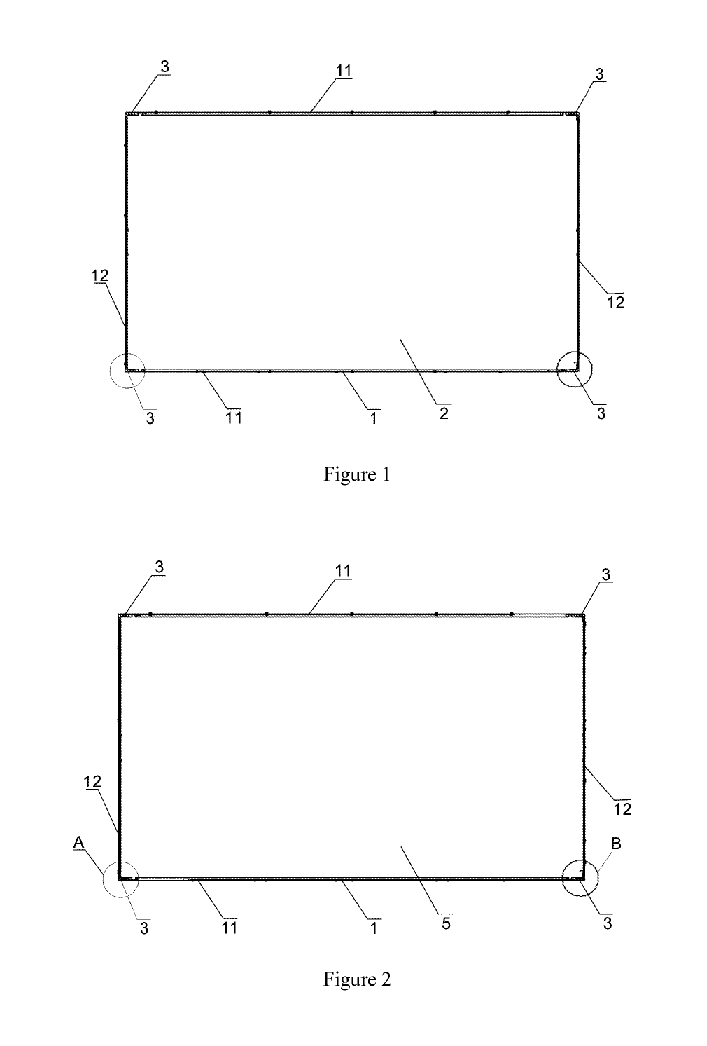

FIG. 1 is a schematic view of the backlight module assembled with the reflective sheet. The backplane 1 include a bottom plate (not shown), and horizontal plates 11 and vertical plates 12 surrounding the bottom plate. The horizontal plates 11 are vertical to the vertical plates 12 so as to form an assembly area within the backplane. The assembly area is for receiving backlight components, such as the reflective sheet 2 and the light guiding plate 5 shown in FIG. 2.

The reflective sheet 2 has two flanges 21 symmetrically arranged on a top side and a down side shown in FIG. 1. The top side is opposite to the down side. The reflective sheet 2 is positioned via engaging the flanges 21 with the positioning device 3 as described below.

In one embodiment, the backlight module includes two sets of positioning device symmetrically arranged in four edge corners between the horizontal plate 11 and the vertical plate 12 of the backplane. The two sets of positioning device connect with the backplane 1 by rivet connection, glue, latches, and so on.

The positioning device 3 is for positioning the reflective sheet 2 and the light guiding plate 5 (as shown in FIG. 2) on the backplane 1. That is, the reflective sheet 2 and the positioning device 3 are fixed by the same positioning device 3. When the location of the reflective sheet 2 is limited, the movement of the light guiding plate 5 drives the reflective sheet 2 to move together with the light guiding plate 5.

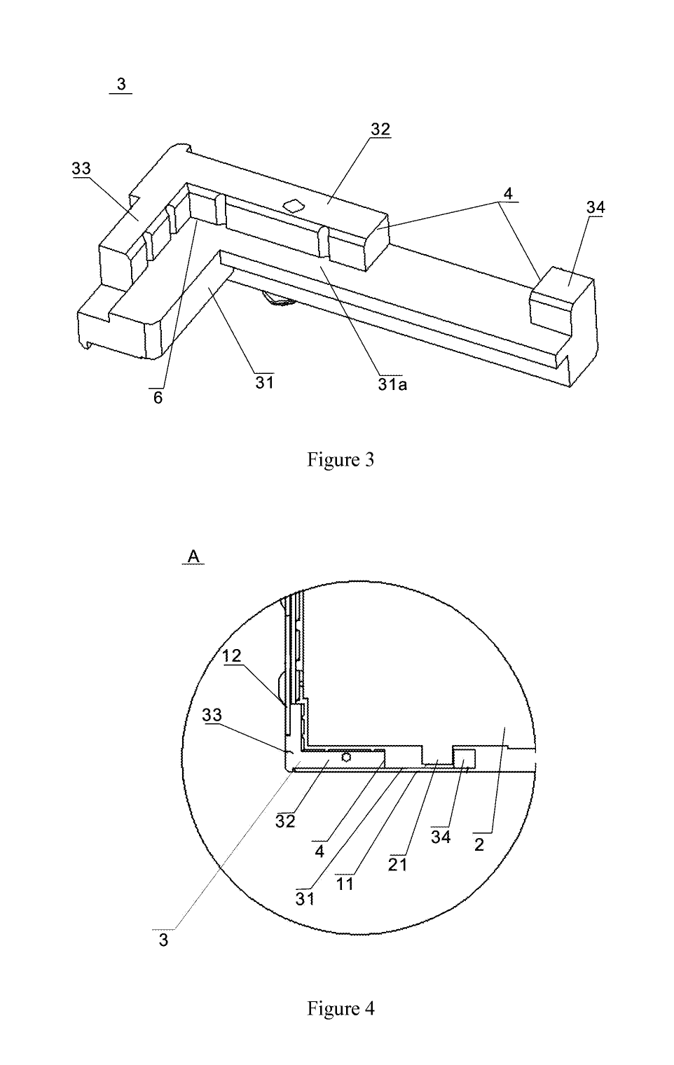

Referring to FIG. 3, the positioning device 3 includes a base 31, a limit member and a protrusion 34. The base 31 is substantially angular-shaped, and includes four corners adaptable to four edge corners of the backplane 1. The base 31 is closely adjacent to the edge corners between the horizontal plate 11 and the vertical plate 12. The base 31 has a top surface 31a for supporting the reflective sheet 2 and the light guiding plate 5.

In one embodiment, the limited member includes a first limit bar 32 and a second limit bar 33. The first limit bar 32 and the second limit bar 33 are protrusively arranged on the top surface 31a of the base 31. Specifically, the first limit bar 32 and the second limit bar 33 are protrusive prisms arranged along edges of the top surface 31a.

The first limit bar 32 and the second limit bar 33 limit the location of the reflective sheet 2. In the embodiment, the first limit bar 32 is vertical to the second limit bar 33. The first limit bar 32 and the second limit bar 33 are connected. In other embodiments, the first limit bar 32 and the second limit bar 33 are integrally formed with the base 31. In this way, the manufacturing process is easier and the cost is lower.

The protrusion 34 is arranged on an edge of the top surface 31a. As shown in FIG. 2, the protrusion 34 is opposite to the lateral first limit bar 32.

The protrusion 34 is block-shaped, and a gap 4 is formed between the first limit bar 32 and the protrusion 34.

The gap 4 provides a buffer for engaging the inflation of the reflective sheet 2.

Preferably, the positioning device 3 may be formed by the following steps. First, the protrusive prism is arranged along the edges of the top surface 31 a of the base 31. The protrusive prism may be integrally formed with the base 31 so that the cost is controlled. Second, the gap 4 is formed by punching the protrusive prism. The gap 4 is for receiving the flanges 21 of the reflective sheet 2. After the gap 4 is formed, the limit member, including the first limit bar 32 and the second limit bar 33, and the protrusion 34 are defined according to the location of the protrusive prism.

The locations of the reflective sheet 2 and the light guiding plate 5 are limited by the limit members and the protrusion 34. Specifically, internal sidewalls of the first limit bar 32, the second limit bar 33, and the protrusion 34 surround the top surface 31a so as to form a limit slot 6 with a right angle.

The four limit slots 6 of the positioning devices form four latching corners. The shape defined by the latching corners is the same with the shape of the light guiding plate 5, and is substantially the same with the shape of the light guiding plate 5. In this way, the light guiding plate 5 may be fixed in the limit slot 6.

The limit slot 6 engages with the gap 4 so as to fix the reflective sheet 2. Specifically, two protrusions 34 of one set of the positioning device may limit the movement of the corresponding flanges 21.

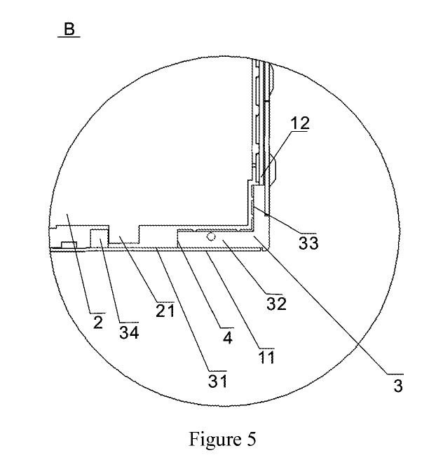

As the shape of the reflective sheet 2 and that of the limit slot 6 are substantially the same, the reflective sheet 2 with the flanges 21 is displaced on the positioning device 3. In this way, the two flanges 21 of the reflective sheet 2 are displaced in the corresponding gap 4. As shown in FIGS. 4 and 5, two opposite edges of the two flanges 21 of the reflective sheet 2 abut against two edges of the protrusions 34 of the positioning device 3 facing away from each other.

In the assembly process, when the reflective sheet 2 moves leftward (see FIG. 5) or moves rightward (see FIG. 4), the protrusions 34 limit the movement of the reflective sheet 2. In this way, the location of the reflective sheet 2 is fixed.

Preferably, a distance between the two opposite edges of the two flanges 21 is equal to a distance between the two edges of the protrusions 34 such that the reflective sheet 2 is fixed.

After the reflective sheet 2 is assembled, the light guiding plate 5 is arranged on the reflective sheet 2. Specifically, the light guiding plate 5 is fixed in the limit slot 6. As the reflective sheet 2 is fixed by the positioning device 3, the location of the reflective sheet 2 is not affected in the assembly process of the light guiding plate 5. That is, the reflective sheet 2 moves together with the light guiding plate 5. FIG. 2 is a schematic view of the backlight module assembled with the light guiding plate 5.

In addition, a width of the gap 4 is larger than that of the flanges 21. Under a high temperature, the reflective sheet 2 inflates toward both sides of the backplane. That is, the positioning device 3 does not affect the buffer for the inflated reflective sheet 2.

In other embodiments, the light guiding plate 5 may be arranged in other locations other than the limit slot 6. For example, the light guiding plate 5 may be arranged in a bottom of the base 31. When the light guiding plate 5 moves, the positioning device 3 drives the reflective sheet 2 to move together. That is, the reflective sheet 2 moves with the light guiding plate 5 so as to ensure the optical uniformity.

By adopting the positioning device, the reflective sheet moves together with the light guiding plate so that the location of the reflective sheet is not affected in the assembly process of the light guiding plate. The protrusions of the positioning device limit the movement of the corresponding flanges of the reflective sheet. As such, the reflective sheet is precisely positioned and the optical uniformity is enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A positioning device of a backlight module for positioning a reflective sheet and a light guiding plate on a backplane, wherein:
the positioning device is for fixing the reflective sheet and the light guiding plate such that the reflective sheet moves together with the light guiding plate.

2. The positioning devices as claimed in claim 1, wherein each of the positioning devices comprises:
a base;
a limit member and a protrusion arranged on a top surface of the base, the protrusion is arranged on an edge of the top surface, wherein:
internal sidewalls of the limit member and the protrusion surround the top surface so as to form a limit slot; and
a gap is formed between the limit member and the protrusion to receive flanges of the reflective sheet such that a movement of the reflective sheet is limited.

3. The positioning devices as claimed in claim 2, wherein the light guiding plate is fixed in the limit slot.

4. A backlight module, comprising:
a backplane, a reflective sheet, a light guiding plate and at least one set of positioning device, the backplane comprises horizontal plates and vertical plates vertical to the horizontal plates, the at least one set of positioning device is arranged in two corners between the vertical plates and the horizontal plate, wherein the reflective sheet and the light guiding plate are respectively fixed by the at least one positioning set such that the reflective sheet moves together with the light guiding plate.

5. The backlight module as claimed in claim 4, the positioning device comprises:
a base;
a limit member and a protrusion arranged on a top surface of the base, the protrusion is arranged on an edge of the top surface, wherein:
internal sidewalls of the limit member and the protrusion surround the top surface so as to form a limit slot, and a gap is formed between the limit member and the protrusion; and
the reflective sheet is received in the limit slot, two flanges of at least one edge of the reflective sheet are respectively arranged in two gaps of the set of positioning device, and the two flanges are limited in the two protrusions of the set of positioning device.

6. The backlight module as claimed in claim 5, wherein the light guiding plate is fixed in the limit slot.

7. The backlight module as claimed in claim 5, wherein a width of the gap is larger than that of the flange so that a buffer is provided for engaging a horizontal inflation of the reflective sheet.

8. The backlight module as claimed in claim 4, wherein two opposite edges of the two flanges abut against two edges of the protrusions facing away from each other.

9. The backlight module as claimed in claim 8, wherein a distance between the two opposite edges of the two flanges is equal to a distance between the two edges of the protrusions facing away from each other.

10. The backlight module as claimed in claim 9, wherein the light guiding plate is fixed in the limit slot.

11. The backlight module as claimed in claim 9, wherein a width of the gap is larger than that of the flange so that a buffer is provided for engaging a horizontal inflation of the reflective sheet.

12. A liquid crystal display, comprising:
a backlight module comprises a backplane, a reflective sheet, a light guiding plate and at least one set of positioning device, the backplane comprises horizontal plates and vertical plates vertical to the horizontal plates, the at least one set of positioning device is arranged in two corners between the vertical plates and the horizontal plate, wherein the reflective sheet and the light guiding plate are respectively fixed by the at least one positioning set such that the reflective sheet moves together with the light guiding plate.

13. The liquid crystal display as claimed in claim 12, wherein the positioning devices comprises:
a base;
a limit member and a protrusion arranged on a top surface of the base, the protrusion is arranged on an edge of the top surface, wherein:
internal sidewalls of the limit member and the protrusion surround the top surface so as to form a limit slot, and a gap is formed between the limit member and the protrusion; and
the reflective sheet is received in the limit slot, two flanges of at least one edge of the reflective sheet are respectively arranged in two gaps of the set of positioning device, and the two flanges are limited in the two protrusions of the set of positioning device.

14. The liquid crystal display as claimed in claim 13, wherein the light guiding plate is fixed in the limit slot.

15. The liquid crystal display as claimed in claim 13, wherein a width of the gap is larger than that of the flange so that a buffer is provided for engaging a horizontal inflation of the reflective sheet.

16. The liquid crystal display as claimed in claim 12, wherein two opposite edges of the two flanges abut against two edges of the protrusions facing away from each other.

17. The liquid crystal display as claimed in claim 16, wherein a distance between the two opposite edges of the two flanges is equal to a distance between the two edges of the protrusions facing away from each other.

18. The liquid crystal display as claimed in claim 17, wherein the light guiding plate is fixed in the limit slot.

19. The liquid crystal display as claimed in claim 17, wherein a width of the gap is larger than that of the flange so that a buffer is provided for engaging a horizontal inflation of the reflective sheet.
